(19) United States
(12) Patent Application Publication
(10) Pub. No.: US 2019/0210775 A1
(43) Pub. Date: Jul. 11, 2019

(54) Universal Single Piece Venting Insert For Container

(71) Applicant: Craig E. Brown, St. Louis, MO (US)

(72) Inventor: Craig E. Brown, St. Louis, MO (US)

(21) Appl. No.: 16/501,184

(22) Filed: Mar. 4, 2019

Related U.S. Application Data
(63) Continuation of application No. 14/120,758, filed on Jun. 24, 2014.
Application No. 14/120,758 is a continuation of application No. 29/620,173, filed on Aug. 3, 2016.

(51) Int. Cl. B65D 47/32; B65D 47/20; B65D 47/06; A47G 19/22; A61J 11/02

(52) U.S. Cl. CPC B65D 47/32; B65D 47/2018; A61J 11/04; A47G 19/2266; A61J 11/02; B65D 47/06

(57) ABSTRACT

A universal single piece venting insert for a container, the insert, when applied, holding a vent tube in position within the container, and extending in proximity with its interior bottom, the vent insert forming a cylindrical member, having an integral flange, the cylindrical member extends through the lid of the container, and the flange is otherwise adhered or held contiguously against the exterior of the lid, to function as a support for the venting structure. The interior of the venting insert, and more specifically its cylindrical member, has a series of communicating channels, a first tapered channel extending upwardly from its bottom, a second flaring portion extending further upwardly within the member, and the remainder being a cylinder forming the vent reservoir, where liquid may accumulate when the container is inverted during consumption of its fluids.

### CROSS REFERENCE TO RELATED APPLICATION

This application claims priority as a continuation-in-part upon U.S. applications having Ser. No. 14/120,758, filed on Jun. 24, 2014, and Ser. No. 29/620,173, filed on Aug. 3, 2016.

### FIELD OF THE INVENTION

This invention relates to the venting of containers, during consumption of their retained liquids, in order to reduce the consumption of air, and more particularly, relates to a universal single piece venting insert for a container, to which a disposable or reusable vent tube may be applied, to vent the interior of any container, whether it be a sports bottle, water bottle, nursing bottle, or the like.

### BACKGROUND OF THE INVENTION

This invention, as explained, relates to the venting of containers. The object of the invention is to avoid the consumption of air bubbles, or other aerations, which can have an adverse effect upon metabolism of the party, for example if they are jogging or running in a race or marathon, and also, to prevent the consumption of aerated formula, when an infant drinks from a container, such as a nursing bottle, so as to provide for full venting of the interior of the container, and prevent the generation of the type of aeration, as described, which can have detrimental and adverse effects upon particular users of the subject container.

There are a myriad of patents that relate to the venting of various bottles. For example, the inventor herein, was involved in the origination of the double venting structure for a nursing bottle, as can be seen in U.S. Pat. No. 5,779,071, in addition to the U.S. Pat. No. 5,570,796. The same inventors have obtained other patents relating to bottle designs with multiple seals, as can be seen in the U.S. Pat. No. 8,479,934. A further patent to the inventors is disclosed in the U.S. Pat. No. 8,113,365. Also, various patents to others, show various types of dispensing devices, such as noted in the U.S. Pat. No. 2,239,275, to Schwab. Another United States Patent shows means for venting of a bottle, as disclosed in U.S. Pat. No. 5,449,098 to Offman. In addition, the published application to Rees, No. US 2008/0099422, discloses a feeding bottle with venting structure.

The foregoing are examples of the various types of prior art structures that are in existence, but the concept of this current invention is to provide a particularly shaped and molded venting insert, that can be permanently or temporarily applied to and through the lid of any container, holding a supply of fluids, as an integral structure, only necessitating the inserting of a vent tube, even one that may be disposable, applied into the interior of the vent insert, in preparation for its usage.

### SUMMARY OF THE INVENTION

The structure of the vent insert includes a tubular or cylindrical member, having internal and communicating variously shaped channels, such as a tapered channel entering into the bottom of the insert, narrowing upwardly therein, and for frictionally engaging a venting tube, even such as a disposable straw, during its assembly. Then, the internal channels extend from the narrowing portion into a volumetric type of reservoir, where any residue fluids within the vent tube can be deposited, when the container is inverted during consumption of its liquid contents. At the top of the widened reservoir, and at the exterior top of the cylindrical member, is an integral flange. The integral flange has a miniscule opening provided through its central portion thereof, to allow for air to vent into the cylindrical member, and through its vent tube, and to enter into the bottom of the inverted container, to provide for entrance of air, and venting of the container structure, so as to prevent the aeration and formation of bubbles within the fluids or formula being consumed, to avoid the type of predicaments as previously commented. Then, the integral flange at the top of the cylindrical member extends outwardly, at a greater diameter, and this flange portion of the cylindrical member or venting insert will remain exteriorly of the cap of any container, and can either be permanently sealed thereto, either by an adhesive, or sonic welding, or the vent insert may be frictionally engaged within the cap of the container, so that it may be removed through the use of some force, when it is desired to undertake its cleansing, after some or repeat usage.

The venting insert of this invention may be formed of a variety of materials, but generally, will be molded of a polymer, to reduce its cost, and to be able to mold it into the precise dimensions as desired, to allow for its application into and through the cap or lid of any container to which it is applied, and for which venting is desired.

It is therefore, the principal object of this invention to provide a venting insert, for ease of application into and through the lid of any fluids container, and which when fully assembled with a vent tube, provides for venting of the interior of the container while its fluids are being consumed. This provides, for the first time, full, continuous, and automatic venting with only one extra component. This component is inexpensive. Double venting and cohesive and adhesive forces are used to prevent leakage.

Another object of this invention is to provide a venting insert that has communicating channels provided through its cylindrical member, in order to allow for the application and retention of a vent tube, such as a straw or other polymer tube, and retain it for venting of the interior of the container during its usage.

A further object of this invention is to provide a venting insert, which interiorly and integrally forms a vent reservoir, where small amounts of residue fluids remaining within the vent tube, as its container is inverted during consumption, accumulates into the formed reservoir, but at the same time, not block the operations of the venting structure, and also prevents the leakage of the reservoir fluids from the vent structure during usage and application.

Still another object of this invention is to provide an integral flange for a venting structure, formed upon the top of its cylindrical member, and which flange will either pressure fit or be adhesively applied exteriorly of the lid of any container holding fluids for which the venting structure of this invention is applied.

Another object of this invention is to provide a venting structure that may cooperate with a disposable straw like member, whether it be formed of paper or polymer, to allow for disposal of such a vent tube, after usage, while the vent insert may readily accept a further disposable straw, for future usage, for venting of such a fluids container during its application and usage. An optionally disposable vent tube can be used, or a permanent vent tube, and can be manually cleaned or placed in a dishwasher, if desired and reused.

Other objects of this invention are to provide a non-vertical superior venting channel to prevent leakage, provide multiple flanges for insert retention, provide an optimal venting tube to prevent leakage by cohesion and adhesive forces, and to provide complete, automatic, and continuous venting with the addition of only one component, which may be disposable or reusable, and is inexpensive.

These and other objects may become more apparent to those skilled in the art upon review of the summary of the invention as provided herein, and upon undertaking a study of the description of its preferred embodiment, in view of the drawings.

### BRIEF DESCRIPTION OF THE DRAWINGS

In referring to the drawings, FIG. 1 is an isometric view, partially sectionalized, for showing part of the exterior of the venting insert, and also the communicating chambers provided within its cylindrical member, to which a vent tube may be applied;

FIG. 2 is a top view of the venting insert of this invention, adhesively applied through the top of the lid of any container, in this instance, comprising a sports type bottle;

FIG. 3 shows an interior view of the container lid, with the inner part of the venting insert extending below the interior of the shown lid, and having a disposable straw applied thereto, to achieve its venting attributes during usage of the fluids container of this invention; and

FIG. 4 shows the lid, with the venting insert, and its vent tube, such as a straw, being inserted into its associated container, in preparation for usage.

### DESCRIPTION OF THE PREFERRED EMBODIMENT

The concept of this invention is to provide a universal one piece venting insert that simply utilizes a narrow and inexpensive vent tube, such as a straw, as its only extra piece required to be applied to the improved venting insert, during its application through the lid of a fluids container. The insert can be attached by an adhesive, sonic welding, or by any other method, or it can even be molded into the lid of the container or bottle, to which it is applied. Furthermore, the insert may be frictionally applied through the lid of the container, and function without leakage of any of the fluids when the container is inverted during consumption of its liquid. But, by frictionally inserting the vent insert through the lid of the container, it can likewise be removed therefrom, to provide for its cleansing, after repeat usage. As will be explained, the vent insert of this invention is designed interiorly having a series of communicating channels, through its cylindrical portion, one of the channels being of a tapered design, in order to hold a narrow diameter venting tube, or straw, therein, to complete the venting structure for the container. Then, the insert has a larger volume space, above the tapering portion, and this functions as a fluids reservoir, for holding any residue liquid from the vent tube, when it is inverted during drinking of liquid from its associated container. And, since there is a miniscule vent hole provided through the upper integral flange of the insert, the hole functions as a venting means, but at the same time, through capillary action, cohesion and adhesion prevent liquid from escaping the bottle and its vent reservoir, when the container is inverted, during consumption of its liquids. This type of structure, that can be applied to a sports bottle, any other drinking bottle, or even to a nursing bottle, allows for a complete, automatic, and full time venting, using only one extra part, namely, the vent insert itself if not attached, and just a vent tube, such as an optionally disposable straw, as the only additional requirement for attaining venting of the interior of the fluids container. If the insert is attached, only the venting tube needs to be added.

In referring to the drawings, and in particular FIG. 1, the venting insert 1 of this invention is readily disclosed. It is shown in partial sectional view, as noted, and it includes a cylindrical member 2, having an integral and enlarged flange 3 applied to its upper edge. Obviously, as can be noted, the flange and cylindrical member 2 may be integrally molded as one piece, during its formation.

The cylindrical member 2 includes a lower entrance channel 4 which has a slight reducing taper as it extends into the channel member 2, and then flares outwardly, as at 5, to form a reservoir portion for the channel, as at 6, as can be noted.

The flange 3, as shown, has a miniscule opening, as at 7, provided therethrough, and this allows for venting of air to enter into the container, particularly when it is inverted, in order to vent the interior of the container structure, and to prevent the aeration of its fluids, as they are being consumed.

It is also to be noted that the flange 3 has a widened diameter, as at 8, being wider than the diameter of the cylindrical member 2, and this portion of the flange is designed for resting upon the top of the lid of the container, and can be either adhesively secured thereto, or secured by sonic weld, or by any other method. Or, as previously summarized, the insert may be frictionally applied through the lid, but yet provide a fluidic seal at the location of its flange 8, so that when it is desired to clean the entire container unit, the venting insert can be pulled therefrom, for cleaning, before it is reinserted for future usage.

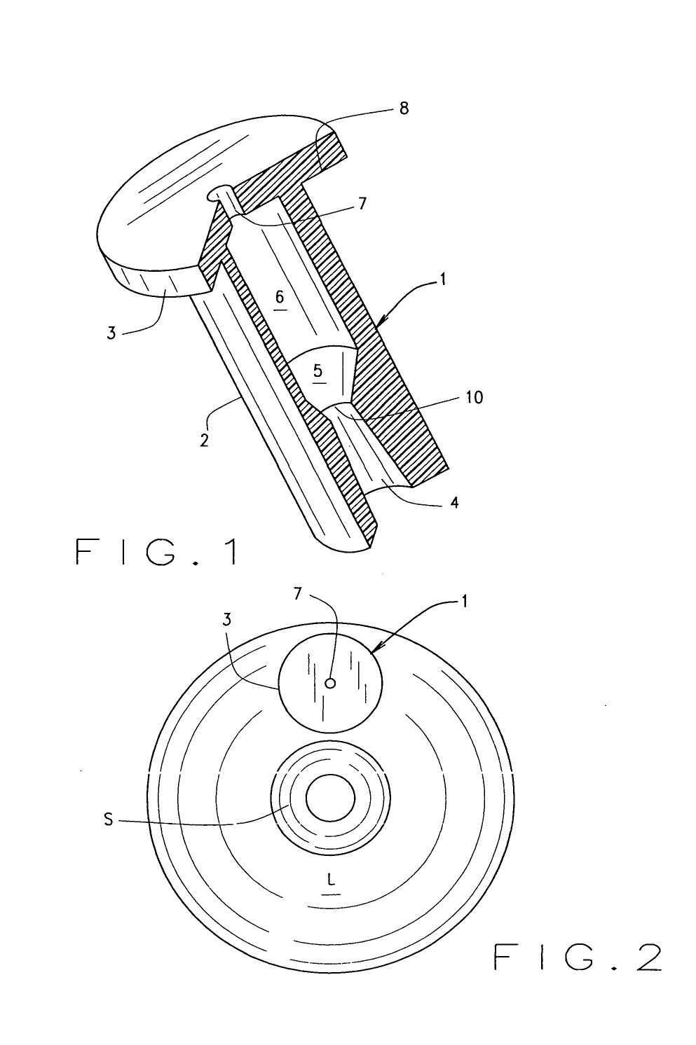

FIG. 2 shows the lid L of the container. The lid has the usual drinking spout S secured thereto, and as known in the art, when its tab is pulled upwardly, it opens an internal valve, that allows for dispensing of the fluids out of the associated container.

But, as also can be noted is the venting insert 1, and more specifically its flange 3, is applied to the top of the lid L, as noted. As stated, it may be adhesively applied thereto, sonic welded thereon, or simply frictionally engaged, to provide for its retention through the lid, when assembled. Also can be seen is the small aperture 7 that allows for air to enter into the venting structure, and to vent the interior of the container, when it is inverted during consumption of its fluids.

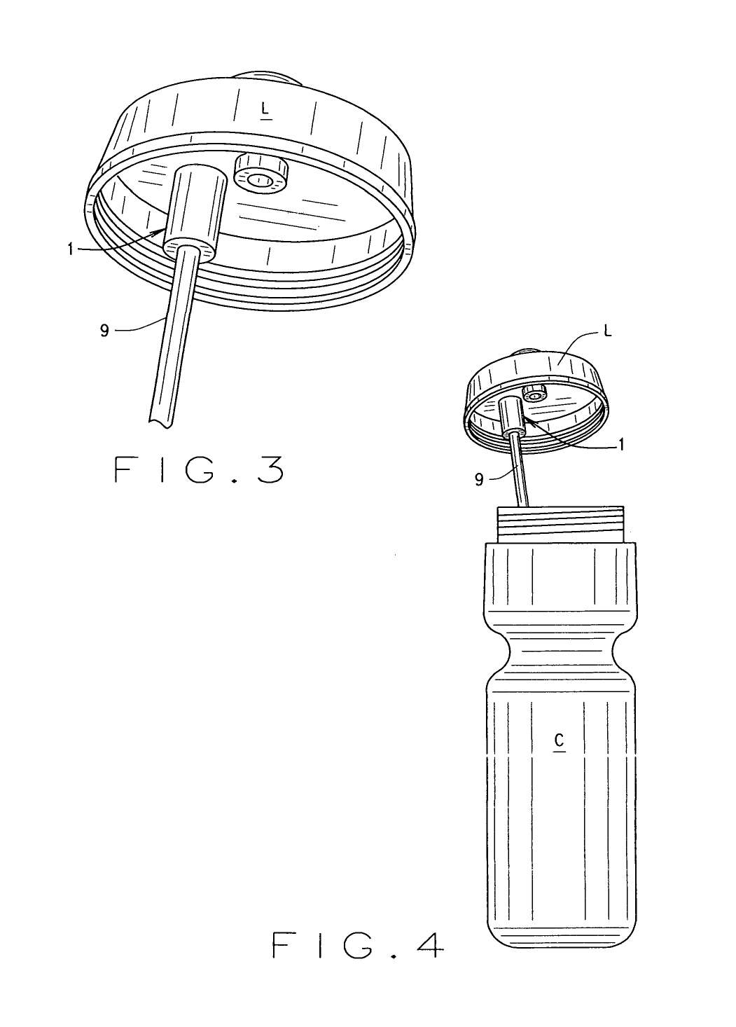

FIG. 3, as previously explained, shows an interior view of the lid L and the vent insert 1 extending therethrough, and below the interior of the lid, as noted. Also shown is the venting tube 9 that extends into the vent insert 1, and within its channel 4, as previously reviewed with respect to the FIG. 1 embodiment. Preferably, the vent tube 9 will be frictionally engaged within the narrowed interior 10 of the insert, and held in position thereat, and even extend a little above the narrowing segment 10, for some distance, to function as a vent, within the reservoir 6, with the reservoir 6 holding any accumulated fluid therein, but not interfere with the entrance of air, through the insert, such as through its narrow passage 7, through the reservoir, and through the vent tube 9, to the bottom of the container, in order to vent the internal structure of the container, during consumption of its fluids, without generating any suction or vacuum pressures therein, during usage.

FIG. 4 shows the container C, with its lid L, placed above the container, and it can be seen that the part of the vent insert 1 extends below the interior of the lid L, and its vent tube or straw 9 as being located within the container, during assembly or installation of the lid L, onto the top of the container C, in preparation for its usage. The container C will already have been filled, or refilled with any liquid, for future consumption, by the user of this device.

Variations or modifications to the subject matter of this invention may occur to those skilled in the art upon review of the invention as described herein. The description of the preferred embodiment of this invention, and its depiction in the drawings, are set forth for illustrate purposes only. Any such variations, within the spirit of this invention, are considered to be encompassed within the scope of any claims to patent protection issuing upon this development.

I claim:

1. A vent insert for use with a fluids container, forming a single piece venting Insert, said insert provided for extending through and having a fluidic seal with the lid of the associated container, said venting insert having a cylindrical member, being integrally formed with an upper flange, where said cylindrical member extends through the lid of the container, and the integral flange adhering to the exterior surface of any lid for the container;
said cylindrical member for the venting insert having a series of internal and communicating channels, an initial channel at its approximate bottom end extending inwardly and tapering to a narrowing diameter, a second communicating chamber that flares or extends wider, and forms the bottom of a reservoir chamber within the insert, the reservoir chamber provided for retaining any residue fluids received from the venting structure when the container is inverted during fluids consumption; and
a vent tube extending below the venting insert, said vent tube pressure fitting within the lower tapering portion of the venting insert and adhered therewith by frictional engagement, the opposite end of said vent tube extending in proximity with the interior bottom of the container, to thereby provide for venting of the interior of the container when fluids consumption is undertaken during usage of the fluids container.

2. The venting insert of claim 1, wherein said vent tube is permanently installed within the venting insert.

3. The venting insert of claim 1, wherein the vent tube is pressure fitted within the proximate bottom of the venting insert.

4. The venting insert of claim 3, wherein said vent tube is formed of a polymer.

5. The venting insert of claim 3, wherein said vent tube is disposable.

6. The venting insert of claim 5, wherein said vent tube is a straw.

7. The venting insert of claim 3, wherein said vent tube is formed of glass.

8. The venting insert of claim 1, wherein said flange is of a greater diameter than the cylindrical member, thereby forming a wider integral flange for the venting insert, which can be contiguously adhered to the exterior of the container lid, and said flange to provide venting, and prevents the escape of any fluids from the cylindrical reservoir through capillary adherence.

9. The venting insert of claim 1, wherein the container is a sports bottle.

10. The venting insert of claim 1, wherein the container is a nursing bottle.

11. The venting insert of claim 6, wherein the superior aspect of said communicating channel, rather than extending vertically through the superior aspect of said cylindrical member and its flange, extends in sloped or horizontal direction and extends from the exterior of said container to the interior of said insert.

12. The venting insert of claim 1, wherein the diameter of said venting tube is approximately 2-3 millimeters and utilizes the forces of adhesion and cohesion, in order to prevent leakage from said container.

13. The venting insert of claim 12, wherein only one extra component is utilizing for complete, automatic and continuous venting.

14. The venting insert of claim 13, wherein only multiple said integral flanges are utilized to maintain the position of said venting insert.

15. The venting insert of claim 14, wherein said flange contains a reservoir space.

16. The venting insert of claim 1, wherein said venting insert can be one of inserted, added to, or integrally molded to the lid of the container.

17. The venting insert of claim 1, wherein said venting insert is integrally molded into the lid of the container.

18. The venting insert of claim 1, said venting insert can be added to the lid of the fluids container during its initial production, or subsequently added to the lid to function as the venting insert for the container.
